(19) United States
(12) Patent Application Publication
(10) Pub. No.: US 2007/0288965 A1
(43) Pub. Date: Dec. 13, 2007

(54) Recommended program information providing method and apparatus

(75) Inventors: Tomoko Murakami, Yokohama-shi (JP); Ryohei Orihara, Tokyo (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha, Tokyo (JP)

(21) Appl. No.: 11/723,188

(22) Filed: Mar. 16, 2007

(30) Foreign Application Priority Data
Mar. 30, 2006 (JP) 2006-095781

(51) Int. Cl. H04N 5/445

(52) U.S. Cl. 725/46

(57) ABSTRACT

An apparatus stores history information of user in first memory, history information including viewing results corresponding to broadcast programs broadcast in the past, each viewing result indicating whether user views or not corresponding one of broadcast programs, stores, in second memory, preference model describing causal relationship between viewing results of user and causes leading to viewing results, stores, in third memory, program guide information including information concerning programs to be broadcast, calculates recommendation degree of each program to be broadcast based on preference model and program guide information, selects, from programs to be broadcast, recommended program based on recommendation degree of each program to be broadcast and viewing result in the history information, viewing result corresponding to one of broadcast programs having specific relationship with each of the programs to be broadcast in predetermined period in the past, and generates recommended program information including information concerning recommended program.

### CROSS-REFERENCE TO RELATED APPLICATIONS

This application is based upon and claims the benefit of priority from prior Japanese Patent Application No. 2006-095781, filed Mar. 30, 2006, the entire contents of which are incorporated herein by reference.

### BACKGROUND OF THE INVENTION

1. Field of the Invention

The present invention relates to recommended program information providing method and apparatus for providing recommended program information concerning recommended programs selected from programs to be broadcasted.

2. Description of the Related Art

With recent advances in multi-channel techniques for digital broadcasting such as CATV, CS broadcasting, and digital terrestrial broadcasting, there is an excessive amount of video content. Under this situation, even the operation of selecting a program to be viewed on TV makes a user feel cumbersome. For this reason, services of selecting programs matching the preference of a user from an enormous number of programs and recommending them to the user have received a great deal of attention. For example, the following techniques related with program recommendation have been provided.

### (1) Program search based on the attributes of programs viewed in past [see JP-A 07-135621 (KOKAI) and JP-A 10-032797 (KOKAI)]

This technique expresses programs by vectors comprising various attributes characterizing the programs, and arranges all the programs in the resultant vector space. The technique then searches for similar programs by calculating Euclidean distances in the vector space on the basis of the attributes of programs viewed by a viewer in the past, and recommend them to the viewer. The technique does not function well unless accumulating a sufficient amount of viewing history of the viewer.

### (2) Recommendation of programs to be viewed using classification model [see JP-A 2000-333085 (KOKAI) and JP-A 2001-160955 (KOKAI)]

This technique is designed to learn a model of classifying programs into those which were viewed by a viewer in the past and those which were not viewed by the viewer, by using, as teacher signal, information indicating whether the viewer viewed each program in the past. The technique then predicts on the basis of this model whether the viewer will view programs to be broadcasted in the future, and recommends the programs which are predicted to be viewed to the viewer. Although the technique can obtain major tendency of programs which the viewer viewed in the past/programs which the viewer did not view, it is difficult to learn rare viewing tendencies.

### (3) Reservation/Recording function based on collaborative filtering [see JP-A 2003-114903 (KOKAI)]

This technique selects, on the basis of the past viewing history of a given viewer A, a viewer B having a similar viewing tendency from many other viewers, and recommends the programs viewed by the viewer B to the viewer A. The technique does function well unless many viewers exist and some of them have similar preferences. In addition, there is difficulty in handling new programs for which no viewing histories are accumulated.

As described above, conventional systems designed to recommend broadcast programs are insufficient to allow program recommendation matching for the preferences and habits of viewers.

### BRIEF SUMMARY OF THE INVENTION

A recommended program information providing apparatus includes: a first memory to store history information of a user, the history information including viewing results corresponding to programs broadcast, each of the viewing results indicating whether the user views or not corresponding program broadcast; a second memory to store a preference model describing a causal relationship between the viewing results of the user and a plurality of causes leading to the viewing results; a third memory to store program guide information including information concerning a plurality of programs to be broadcast; a calculation unit configured to calculate a recommendation degree of each of the programs to be broadcast based on the preference model and the program guide information; a selection unit configured to select, from the programs to be broadcast, a recommended program based on the recommendation degree of each of the programs to be broadcast and a viewing result in the history information, the viewing result corresponding to a program broadcast having a specific relationship with the each of the programs to be broadcast in a predetermined period in the past; and a generation unit configured to generate recommended program information including information concerning the recommended program.

### BRIEF DESCRIPTION OF THE SEVERAL VIEWS OF THE DRAWING

FIG. 1 is a block diagram showing the schematic arrangement of a recommended program information providing apparatus according to an embodiment;

FIG. 2 is a view showing an example of the preference model of a viewer;

FIG. 3 is a flowchart showing an example of a procedure for generating a preference model in the recommended program information providing apparatus according to the embodiment;

FIG. 4 is a view showing an example in which the structure of a preference model shown in FIG. 2, which is written in a computer-readable form by a Bayesian network;

FIG. 5 is a view showing an example of TV program information;

FIG. 6 is a view showing an example of the viewing history information of a given viewer with respect to the TV program information shown in FIG. 5;

FIG. 7 is a view showing an example of the values of a conditional probability table which are calculated and output in accordance with the preference model shown in FIG. 2;

FIG. 8 is a flowchart showing an example of a procedure for generating recommended program information in the recommended program information providing apparatus according to the embodiment; and

FIG. 9 is a view showing an example of recommended program information.

### DETAILED DESCRIPTION OF THE INVENTION

An embodiment of the present invention will be described below with reference to the views of the accompanying drawing.

Note that the following description will be made by taking, as an example, a case wherein content (TV programs) to be televised is handled as targets, and content matching the preference of a viewer is selected and recommended to the viewer. However, this embodiment is not limited to this, and can be applied to broadcast content in general (e.g., satellite broadcast programs, wire broadcast programs, and Internet broadcast programs).

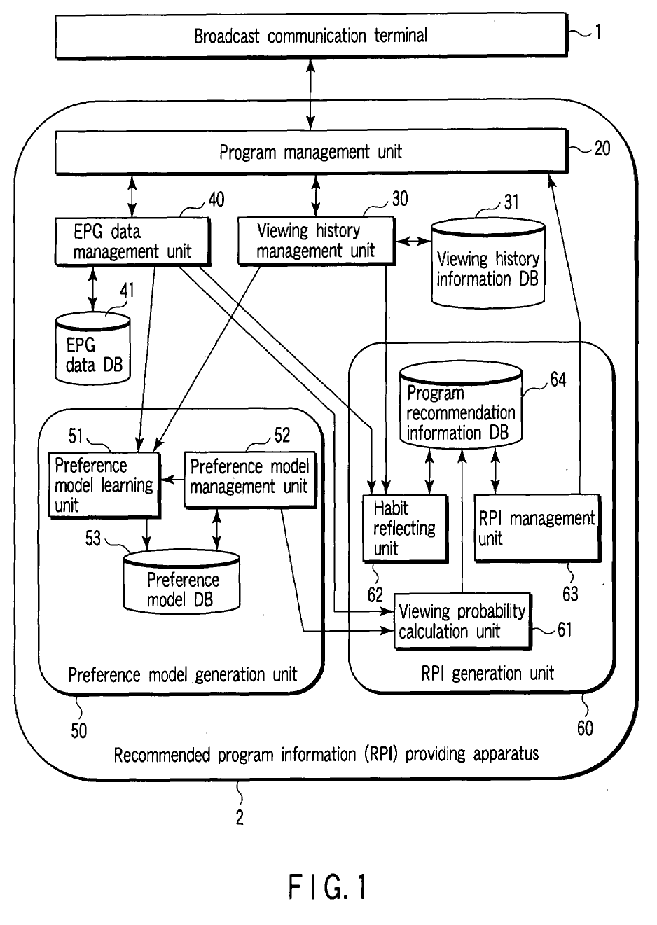

FIG. 1 shows an example of the arrangement of a recommended program information (RPI) providing apparatus according to the embodiment.

As shown in FIG. 1, an RPI providing apparatus 2 according to this embodiment includes a program management unit 20, viewing history management unit 30, electronic program guide (EPG) data management unit 40, preference model generation unit 50, and recommended program information (RPI) generation unit 60.

The program management unit 20 manages the information of programs. More specifically, the program management unit 20 acquires electronic program information (electronic program guide) (to be referred to as EPG data hereinafter) or the viewing history information of a (specific) viewer from a broadcast communication terminal 1, and provides recommended program information (RPI) to the broadcast communication terminal 1. The program management unit 20 also exchanges necessary information with the respective units in the RPI providing apparatus 2.

Note that the RPI providing apparatus 2 may incorporate the broadcast communication terminal 1, or may be an apparatus independent of the broadcast communication terminal 1. In the latter case, the program management unit 20 comprises a user interface for communication with the broadcast communication terminal 1.

The broadcast communication terminal 1 receives EPG data from, for example, an external broadcast communication device, and acquires the viewing history information of a viewer by, for example, monitoring the TV operation by the viewer.

The broadcast communication terminal 1 displays the recommended program information provided from the RPI providing apparatus 2.

Referring to FIG. 1, the RPI providing apparatus 2 can also be configured to receive EPG data and/or viewing history information from an apparatus other than the broadcast communication terminal 1 and to provide recommended program information to an apparatus other than the broadcast communication terminal 1.

Note that this embodiment exemplifies TV programs as broadcast content, and hence EPG data, the viewing history information of a viewer, and recommended program information which are used for the following description are associated with TV programs. However, the present invention is not limited to the content exemplified by the embodiment, and may be applied to information having various formats and definitions. In addition, such information can be input in various forms, e.g., keyboard input, remote control input, online input through a network, and reading from a magnetic tape as an information transfer medium.

The EPG data management unit 40 receives and manages EPG data from the program management unit 20, and periodically updates the data. The EPG data input to the EPG data management unit 40 is recorded on an electronic program guide data database (EPG data DB) 41.

The viewing history management unit 30 receives and manages the viewing history information of the viewer from the program management unit 20, and periodically updates the information. The viewing history information input to the viewing history management unit 30 is recorded on a viewing history information DB 31.

The preference model generation unit 50 generates a preference model describing program viewing preference by the viewer on the basis of the EPG data and the viewing history information. As shown in FIG. 1, the preference model generation unit 50 includes a preference model learning unit 51, preference model management unit 52, and preference model database (preference model DB) 53.

The preference model learning unit 51 receives EPG data in a predetermined period in the past and the pieces of viewing history information of the viewer which correspond to them from the EPG data management unit 40 and viewing history management unit 30, and generates a preference model on the basis of these pieces of information. Note that the preference model learning unit 51 also has a function of receiving EPG data concerning a program to be broadcast in the future and viewing history information and updating the preference model periodically or at point of time when a predetermined number of data are input.

The preference model management unit 52 manages structure definition data and conditional probability values, which will be described in detail later, as a preference model.

The preference model DB 53 is used to record the preference model generated by the preference model learning unit 51.

The RPI generation unit 60 selects programs matching the preference of the viewer as programs to be recommended on the basis of the preference model generated by the preference model generation unit 50 and the EPG data concerning the programs as recommendation candidates. The RPI generation unit 60 then generates recommended program information containing information concerning the selected recommended programs. The RPI generation unit 60 includes viewing probability calculation unit 61, habit reflecting unit 62, recommended program information (RPI) management unit 63, and program recommendation information database (DB) 64.

The viewing probability calculation unit 61 receives the EPG data from the EPG data management unit 40 and the conditional probability values of the preference model from the preference model management unit 52, and calculates the probabilities of viewing TV programs to be broadcast (the viewing probabilities of TV programs to be broadcast), thereby generating a recommended program list in which data containing at least pieces of information which can specify programs as recommendation candidates and probabilities obtained with respect to the programs are arranged in the descending order of probabilities. In this case, the probabilities are used as recommendation degrees.

Although described in detail later, when, for example, an already broadcast program having a specific relationship with a given program to be broadcast exists in a predetermined period in the past, the habit reflecting unit 62 corrects the probability of viewing the program to be broadcast or removes the program to be broadcast from the candidate list.

The RPI management unit 63 selects programs to be recommended on the basis of the content of the recommended program list, and generates recommended program information including information concerning recommended programs which is necessary to present recommended programs to the viewer.

The program recommendation information DB 64 stores the recommended program list and the recommended program information.

The operation of the recommended program information providing apparatus according to this embodiment will be described next.

A procedure for generating a preference model in the preference model generation unit 50 of the recommended program information providing apparatus according to this embodiment will be described first.

The preference model generation unit 50 generates a preference model describing a program viewing preference by the viewer on the basis of EPG data and viewing history information in a predetermined period in the past.

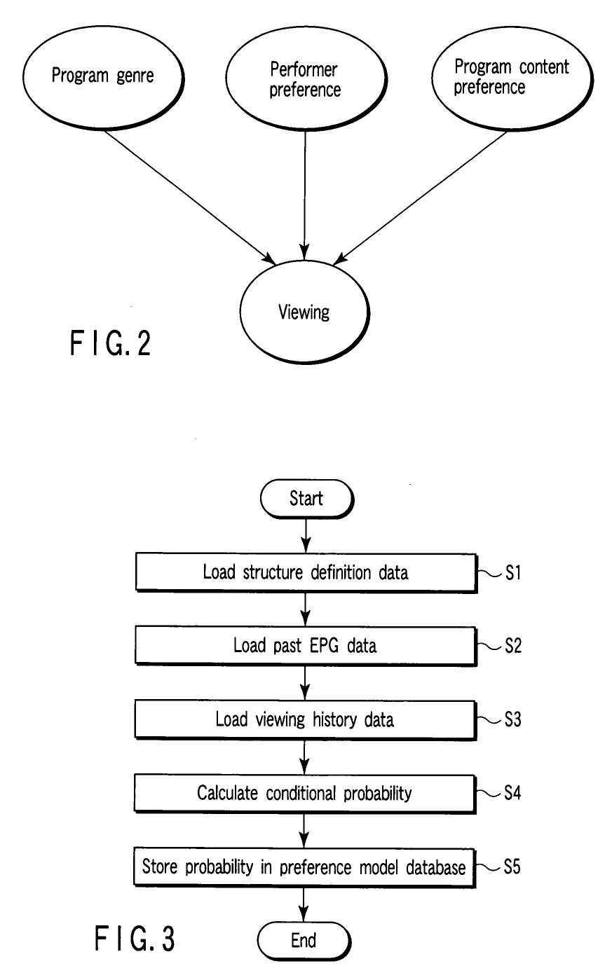

FIG. 2 shows an example of a preference model as a target in this embodiment.

The preference model shown in FIG. 2 is a model expressed by a Bayesian network. Bayesian network is a probability network which is a probability model based on a graph structure obtained by expressing random variables by nodes and establishing links between variables having dependency relationships such as casual relationships or correlations. A preference model expressed by a Bayesian network is a model expressed by an acyclic directed graph in which links are directed to the direction of casual relationships and paths tracing the links are not cyclic. The preference model shown in FIG. 2 is a preference model describing “program genre”, “performer preference”, “program content preference”, and “viewing” as random variables, and a casual relationship in which the random variable “program genre”, the random variable “performer preference”, and the random variable “program content preference” influence the random variable “viewing”.

Note that the preference model shown in FIG. 2 is an example, and this embodiment is not limited to this.

FIG. 3 shows an example of a procedure for generating a preference model according to this embodiment.

The preference model learning unit 51 of the preference model generation unit 50 loads structure definition data defining the structure of a preference model (step S1).

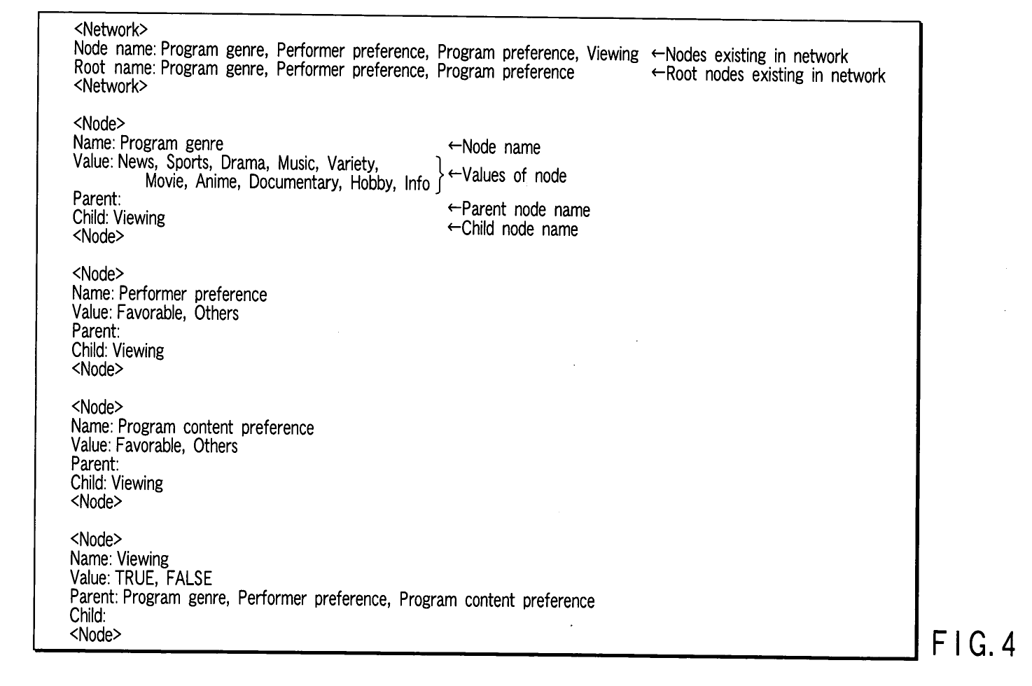

FIG. 4 shows an example of this structure definition data. The data in FIG. 4 describes the structure of a Bayesian network in the preference model exemplified in FIG. 2 in a computable-readable form.

The structure definition data in FIG. 4 defines four elements, i.e., “program genre”, “performer preference”, “program content preference”, and “viewing” as random variables. The values, which the respective random variables take, are also defines. For example, the data indicates, as the values of the random variable “program genre”, that there are 10 kinds of values, namely “news (News)”, “sports (Sports)”, “drama (Drama)”, “music (Music)”, “variety (Variety)”, “movie (Movie)”, “animation (Anime)”, “documentary (Documentary)”, “hobby (Hobby)”, and “information (Info)”. Likewise, the data indicates that the random variable “performer preference” takes two kinds of values, namely “favorable” and “others”, the random variable “program content preference” takes two kinds of values, namely “favorable” and “others”, and the random variable “viewing” takes two kinds of values, namely “to view (TRUE)” and “not to view (FALSE)”. In addition, in order to define a casual relationship, the data describes “parent node (Parent)” as a cause random variable and “child node (Child)” as a result random variable.

The preference model learning unit 51 loads EPG data in a predetermined period in the past from the EPG data management unit 40 (step S2).

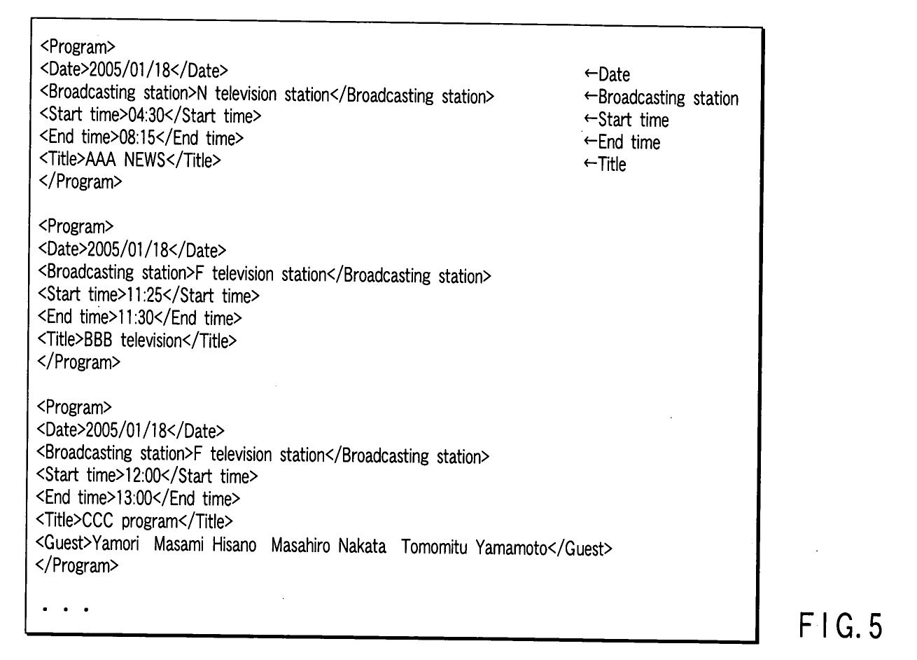

FIG. 5 shows an example of this EPG data (TV program information). The EPG data exemplified in FIG. 5 includes attributes such as a date, broadcasting station, start time, end time, and title for each program. Note that other attributes such as guest information are added to this data, as needed. The data shown in FIG. 5 indicates that in Jan. 18, 2005, the TV program with the title “AAA NEWS” was broadcast on the N television station from 4:30 to 8:15, the TV program with the title “BBB television” was broadcast on the F television station from 11:25 to 11:30, and the TV program with the title “CCC program” was broadcast on the F television station from 12:00 to 13:00. This data also indicates that Yamori, Masami Hisano, Masahiro Nakata, and Tomomitu Yamamoto appeared as guests on the TV program with the title “CCC program”.

The preference model learning unit 51 loads viewing history information in a predetermined period in the past from the viewing history management unit 30 (step S3).

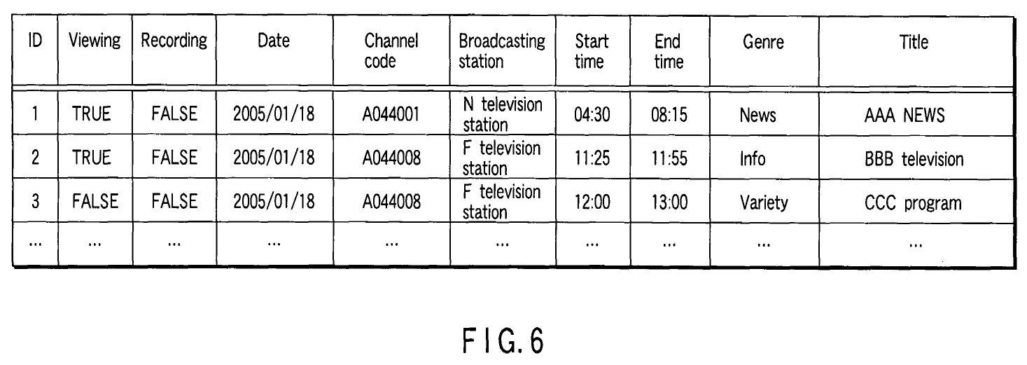

FIG. 6 shows an example of the viewing history information of a given viewer with respect to the EPG data exemplified in FIG. 5. Referring to FIG. 6, the symbol “TRUE” or “FALSE” is used to indicates viewing history information with respect to the EPG data shown in FIG. 5. More specifically, the attribute “TRUE” indicates that the program was viewed or recorded, and the attribute “FALSE” indicates that the program was not viewed or recorded. In the specific example shown in FIG. 6, “BBB television” and “AAA NEWS” are the programs with the attribute “viewing” being set to “TRUE”. In the case shown in FIG. 6, therefore, the viewer viewed these two programs but did not record them. In this case, this viewing history information is information indicating that the viewer actually viewed the program or did not view it.

Note that the execution order of steps S1 to S3 may be arbitrarily changed. Alternatively, it suffices to execute these steps in parallel.

The preference model learning unit 51 calculates the conditional probability value of each random variable in the Bayesian network (step S4). The preference model DB 53 then stores these values together with structure definition data as a preference model (step S5). The calculation method for conditional probability values in step S4 may calculate the frequency of programs matching a condition as a conditional probability value from viewing history information in a predetermined period in the past like that shown in FIG. 6 or obtains such a value by making a system designer set an arbitrary value.

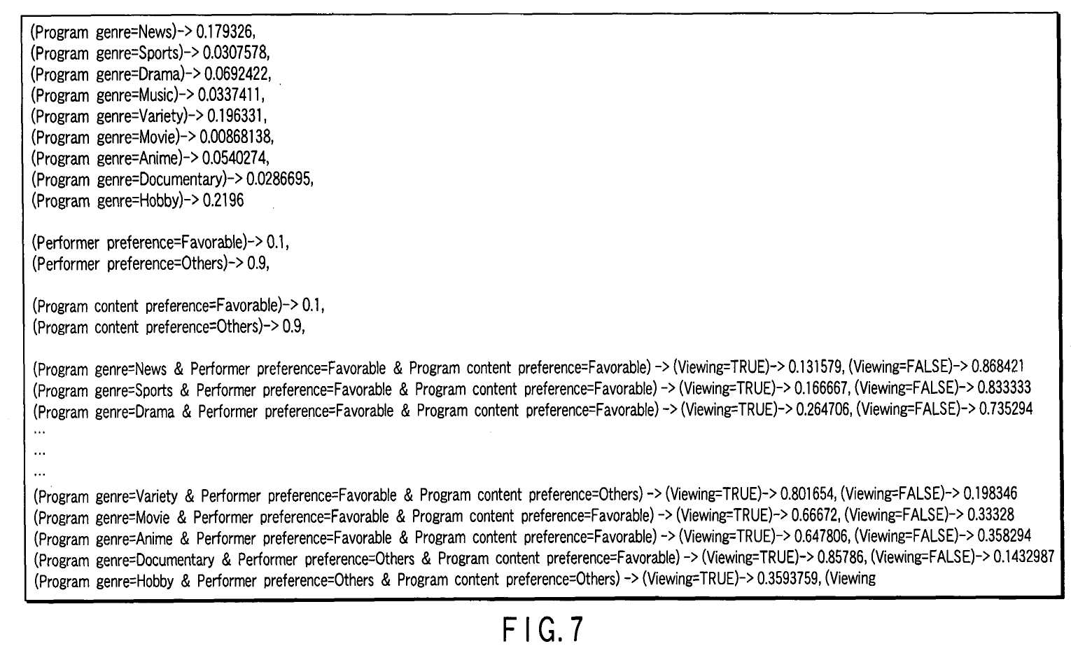

FIG. 7 shows an example of the values of a conditional probability table which this embodiment calculates and outputs. In this case, the values of a conditional probability table are calculated by using the viewing history of the viewer which is shown in FIG. 6. However, it suffices to make the system designer or the user set arbitrary values in advance.

Referring to FIG. 7, probability values are defined in case wherein the random variable “program genre” takes various values. For example, the description of the first line

(program genre=News)->0.179326

indicates that the probability value of the program with the program genre “news” is “0.179326”. This value can be obtained by, for example, calculating the frequency of programs, of all the programs included in the viewing history of the viewer shown in FIG. 6, which have “news” as the value of the random variable “program genre”. Likewise, the following defines the probability values of various program genres such as “sports” and “drama”.

With regard to the random variable “performer preference” in FIG. 7, the degree of preference concerning a performer is defined as a binary random variable. For example, in FIG. 7, the description

(performer preference=favorable)->0.1

indicates that the occurrence probability of a program whose value of the random variable “performer preference” is “favorable” (i.e., a program on which a favorable performer appears) is “0.1”. According to a procedure for determining this value, for example, first of all, a list of performers favored by the viewer is generated by regarding the performers on viewed programs contained in the viewing history of the viewer shown in FIG. 6 as performers favored by the viewer. Preference information (“favorable” or “others”) of each performer on each program is then assigned to the list by referring to the generated list. Furthermore, the frequency of each program to which each piece of preference information in all the programs is assigned is counted up.

With regard to “program content preference” in FIG. 7, the degree of preference concerning program content is defined as a binary random variable. For example, in FIG. 7, the description

(program content preference=favorable)->0.1

indicates that the occurrence probability of a program whose value of the random variable “program content preference” is “favorable” (i.e., a program with favorable content) is “0.1”. According to a procedure for determining this value, for example, first of all, a list of keywords favored by the viewer is generated by extracting keywords from the program content of viewed programs included in the viewing history of the viewer shown in FIG. 6 and regarding the extracted keywords as keywords of programs favored by the viewer. Preference information (“favorable” or “others”) of each program content is then assigned to the list by referring to the generated list. Furthermore, the frequency of each program to which each piece of preference information in all the program content is assigned is counted up.

The random variable “program genre”, the random variable “performer preference”, and random variable “program content preference” influence the probability value of the random variable “viewing” in accordance with the preference model shown in FIG. 2. Therefore, the probability value of the random variable “viewing” is defined under the condition of all variations of the respective values of the random variable “program genre”, random variable “performer preference”, and random variable “program content preference”. For example, the fifth line counted from below in FIG. 7

(program genre=Variety & performer preference=favorable & program content preference=others)->(viewing=TRUE)->0.801654, (viewing=FALSE)->0.198346

indicates that the probability value with which the viewer will view a program whose value of the random variable “program genre” is “variety”, whose value of the random variable “performer preference” is “favorable”, and whose value of the random variable “program content preference” is “others” is “0.801654”, and that the probability value with which the viewer will not view the program is “0.198346”. These values can be obtained by, for example, calculating, in accordance with the occurrence frequencies in the viewing history of the viewer shown in FIG. 6, the frequencies of programs with and without the random variable “viewing”, of programs, included in the viewing history, whose value of the random variable “program genre” is “variety”, whose value of the random variable “performer preference” is “favorable”, and whose value of the random variable “program content preference” is “others”.

A procedure for generating recommended program information in the RPI generation unit 60 of the recommended program information providing apparatus according to this embodiment will be described next.

The RPI generation unit 60 generates recommended program information on the basis of the preference model generated by the preference model generation unit 50 on the basis of EPG data and viewing history information in a predetermined period in the past and EPG data concerning programs as recommendation candidates to be broadcast in the future.

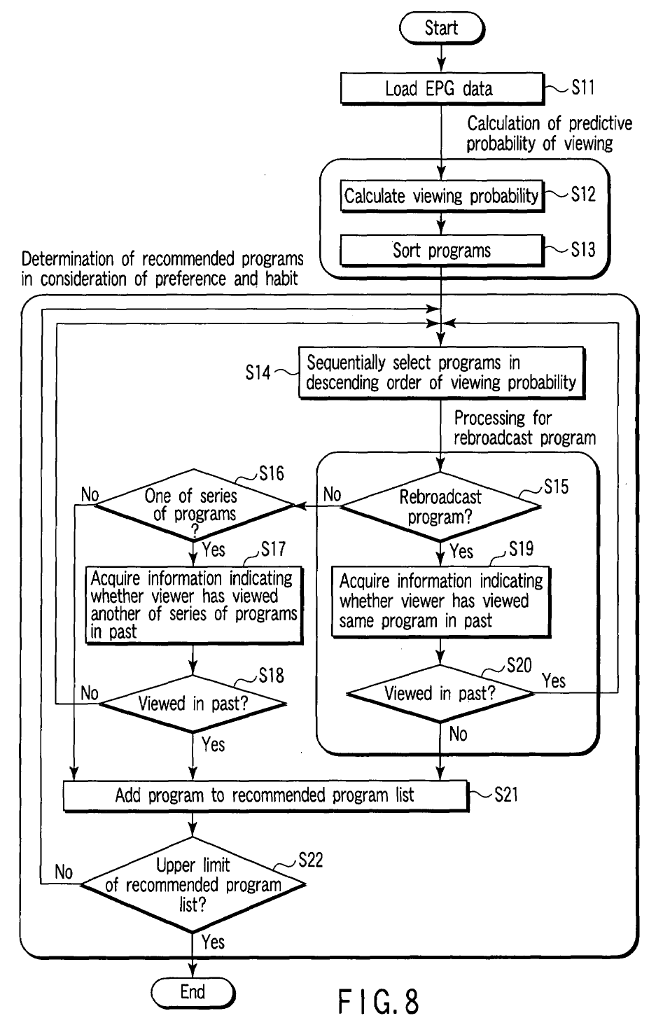

FIG. 8 shows a procedure for generating recommended program information in this embodiment.

First of all, the viewing probability calculation unit 61 of the RPI generation unit 60 loads EPG data (e.g., EPG data like that shown in FIG. 5) concerning programs to be broadcast, which are managed by the EPG data management unit 40 and are targets in the following processing (step S11).

The viewing probability calculation unit 61 calculates the probability value (viewing probability) of the viewer with respect to each TV program to be broadcast in the future on the basis of this EPG data and the conditional probability values of the preference model from the preference model management unit 52 (step S12).

These probability values are obtained by probability inference on the preference model. For example, if it is obvious that the program genre of a TV program to be broadcast in the future is “variety”, the viewing probability calculation unit 61 calculates a probability P (viewing=TRUE|program genre=Variety) of a given viewer with respect to this program according to

P (viewing=TRUE|program genre=Variety)=P (viewing=TRUE).P (program genre=Variety|viewing=TRUE)/P (program genre=Variety)

by using a probability distribution such as the conditional probability values shown in FIG. 7.

Note that if the preference model defined by the structure definition data shown in FIG. 4 has a complicated structure, since the calculation amount is excessively large, it is preferable to perform this calculation by an approximate calculation technique. Various approximate calculation techniques have been proposed: loopy belief propagation (e.g., K. P. Murphy, Y. Weiss, and M. I. Jordan, “Loopy belief propagation for approximate inference”, an empirical study, In Proc. of Conf. Uncertainty in Artificial Intelligence (UAI-99), (1999)), and various sampling techniques (e.g., M. Henrion, “Propagation of uncertainty by probabilistic logic sampling in Bayes' networks”, In J. F. Lemmer & L. N. Kanal (Eds.), Uncertainty in Artificial Intelligence 2, pp. 149-163, (1988), and R. Fung, and C. K. Chang, “Weighting and integrating evidence for stochastic simulation in Bayesian networks”, In Proc. of Conf. Uncertainty in Artificial Intelligence (UAI-89), (1989)). It suffices to use any one of these techniques.

The viewing probability calculation unit 61 generates a recommended candidate program list in which data including at least pieces of information which can specify the respective programs and the probabilities obtained with respect to the programs are arranged in the descending order of the probabilities (step S13). The program recommendation information DB 64 stores this list. Note that the recommended candidate program list may be configured such that probabilities are added to the data of the respective programs of the EPG data, and the data are rearranged in the descending order of the probabilities.

In this case, programs to be recommended are selected from the TV programs in the recommended candidate program list on the basis of the habit acquisition result acquired by the habit reflecting unit 62, and the selected recommended programs are added to the recommended program list (in the descending order).

The habit reflecting unit 62 extracts TV programs in the recommended candidate program list, in which the programs are arranged in the descending order in the above manner and which is stored in the program recommendation information DB 64, one by one in the descending order of probabilities, and sets the extracted programs as targets in the following processing (step S14).

First of all, it is determined whether a target TV program (to be referred to as a target program hereinafter) is a repeat (rebroadcast program) (step S15).

If the target program is a repeat, information indicating whether the viewer has viewed any TV program which has already been broadcast and can be specified as having the same content as that of the target program is acquired (step S19). As methods of specifying that the target program has the same content as that of the already broadcast TV program, various methods have been proposed, e.g., a method of detecting a program which matches a program title name in the EPG data, and a method of finding a description indicating that a given program is a repeat.

If the acquired information indicates that the viewer has not viewed such a program (step S20), the target program is selected as a program to be recommended, and the information of the TV program is added to the recommended program list (step S21).

If the information indicates that the viewer has viewed such a program (step S20), the process returns to step S14 to select one of programs which has the next highest probability from the recommended candidate program list.

If the target program is not a repeat (rebroadcast program), it is determined whether the program is a serial broadcast program or one of a series of programs (step S16). Note that a serial broadcast program or one of a series of programs may have any form in terms of the relationship between the content of the respective broadcasts. For example, each broadcast may have independent content, or the content of the respective broadcasts may have continuity.

If the target program is not a serial broadcast program or one of a series of programs, the target program is selected as a program to be recommended, and the information of the TV program is added to the recommended program list (step S21).

If the target program is a serial broadcast program or one of a series of programs, information is acquired, which indicates whether the viewer has viewed a program that precedes the target program in the serial or the series of programs (e.g., if the target program is the third broadcast of the serial or a series of programs, this program is an already broadcast program corresponding to the second broadcast which is the immediately preceding broadcast in the same serial or the series of programs) (step S17). As methods of determining whether a selected program is a serial broadcast program or one of a series of programs, various methods can be proposed, e.g., a method of detecting a program which matches a program title name in EPG data, and a method of finding a description indicating a serial broadcast program or a series of programs from episode information.

If it is determined that the viewer has viewed a program that precedes the target program in the serial or the series of programs in a predetermined period in the past (step S18), the target program is selected as a program to be recommended, and the information of the TV program is added to the recommended program list (step S21).

If the viewer has not viewed such a program (step S18), the process returns to step S14 to select a program with the next highest probability from the recommended candidate program list.

In generating a recommended program list in the above manner, every time the size of the recommended program list changes, the size is compared with a threshold concerning the size of a recommended program list (e.g., the upper limit of the number of programs) (step S22). If the size does not exceed the threshold, the process returns to step S14. If the size exceeds the threshold, this processing is terminated (if the above processing is performed for all the TV programs in the EPG data as a target before the size of the recommended program list exceeds the threshold, the processing is terminated).

The above method uses a threshold concerning the size of a recommended program list (i.e., the lower limit of the order obtained by sorting probability values (a method of selecting a program having a probability value which provides a higher rank than this lower limit)) as a condition for terminating the generation of a recommended program list. However, another method can also be used, e.g., a method using the lower limit of probability values (a method of selecting a program having a probability equal to or higher than the lower limit).

The RPI management unit 63 generates recommended program information including information concerning recommended programs, which is required to present the recommended programs to the viewer, on the basis of the recommended program list generated in the above manner, and transfers the generated information to the program management unit 20. The program management unit 20 transmits this recommended program information to the broadcast communication terminal 1. Note that the broadcast communication terminal 1 presents the received recommended program information to the user.

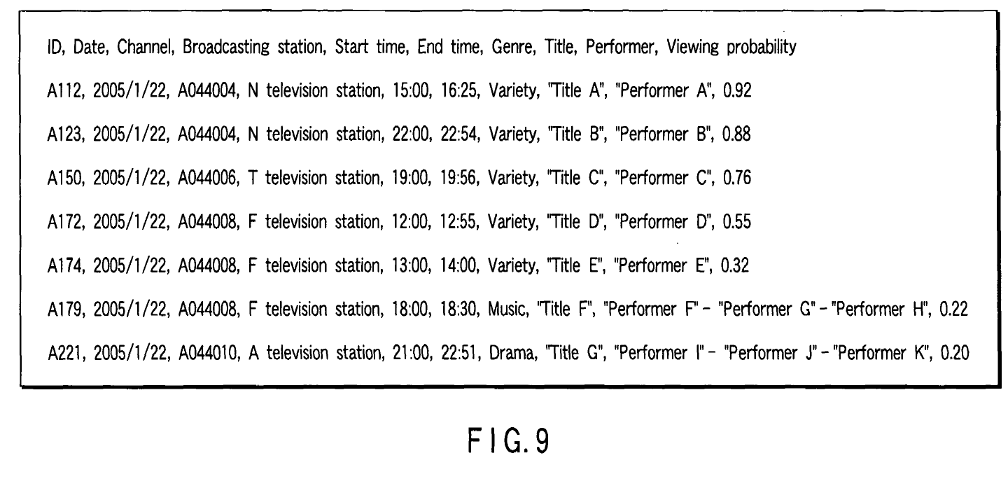

FIG. 9 shows an example of recommended program information generated in this embodiment. Referring to FIG. 9, the program with the title “title A” has the highest probability, i.e., “0.92”, that the viewer will view, and is presented as a recommended program.

According to the procedure in FIG. 8, it is determined first whether the target TV program is a repeat (rebroadcast program), and it is then determined whether the target program is a serial broadcast program or one of a series of programs. However, it suffices to determine first whether the target program is a serial broadcast program or one of a series of programs and then determine whether the target program is a rebroadcast program. Alternatively, it suffices to simultaneously determine whether the target TV program is a rebroadcast program, a serial broadcast program or one of a series of programs, or a program other than them.

According to the above description, the viewing probability calculation unit 61 generates a recommended candidate program list, and the habit reflecting unit 62 adds recommended programs selected from the recommended candidate program list to the recommended program list (in the descending order). Instead of this operation, the viewing probability calculation unit 61 may generate a recommended candidate program list, and the habit reflecting unit 62 may delete, from the recommended program list, a program which has not been selected from the recommended candidate program list.

As described above, the above embodiment allows program recommendation more matching the personal preference and habit of each viewer.

Note that the habit reflecting unit 62 can perform processing in various forms.

For example, according to the above description, when a target program is a serial broadcast program or one of the series of programs, if the viewer has not viewed a program preceding the target program in the serial or the series of programs in a predetermined period in the past, the target program is not selected. However, whether to select the target program can also be determined in accordance with viewed states with respect to all the programs belonging to the serial or the series in a predetermined period in the past. For example, this processing can use various methods, e.g., a method of performing determination on the basis of the evaluation value obtained as a result of dividing the number of viewed programs of all the programs belonging to the serial or the series of programs broadcast in a predetermined period in the past by the total number of programs, and a method of performing such determination by obtaining an evaluation value by assigning a higher weight to a program closer to the current program.

In addition, if, for example, an already broadcast program having a specific relationship with a given program to be broadcast exists in a predetermined period in the past, it suffices to correct the probability of the program to be broadcast depending on whether the viewer has viewed the already broadcast program.

When, for example, a target program is a serial broadcast program or one of the series of programs, if the viewer has not viewed a program preceding the target program in the serial or the series of the programs in a predetermined period in the past, it suffices to further decrease the probability value of the target program, with “0” being the lower limit (for example, a predetermined value is subtracted from the probability value, the probability value is divided by a predetermined value, or the probability value is set to “0”).

In addition, when, for example, a target program is a serial or one of the series of programs, if the viewer has viewed a program preceding the target program in the serial or the series of programs in a predetermined period in the past, it suffices to further increase the probability value of the target program (with “1” being the upper limit) (for example, a predetermined value is added to the probability value, the probability value is multiplied by a predetermined value, or the probability value is set to “1”).

When, for example, a target program is a serial broadcast program or one of the series of programs, it suffices to properly adjust the probability value of the target program in accordance with viewed states with respect to all the programs belonging to the serial or the series of the programs broadcast in a predetermined period in the past. This processing can use various methods, e.g., a method of increasing/decreasing the probability value of the target program in accordance with the evaluation value obtained by dividing the number of viewed programs of all the programs belonging to the serial or the series of programs broadcast in a predetermined period in the past by the total number of programs, and a method of performing such determination by obtaining an evaluation value by assigning a higher weight to a program closer to the current program.

When, for example, a target program is a rebroadcast program, if the viewer has viewed a program which can be specified as having the same content in a predetermined period in the past, it suffices to further decrease the probability value of the target program, with “0” being the lower limit (for example, a predetermined value is subtracted from the probability value, the probability value is divided by a predetermined value, or the probability value is set to “0”).

In addition, when, for example, a target program is a rebroadcast program, if the viewer has not viewed any program which can be specified as having the same content in a predetermined period in the past, and the probability value of the target program is equal to or more than predetermined reference value, it suffices to further increase the probability value of the target program (with “1” being the upper limit) (for example, a predetermined value is added to the probability value, the probability value is multiplied by a predetermined value, or the probability value is set to “1”).

Furthermore, with regard to habit, programs in forms different from serial broadcast programs, a series of programs and rebroadcast programs can be processed as target programs. Assume that an already broadcast program is a special program for advertising a program to be broadcast or a program to be broadcast is a special program which introduces a production scene of an already broadcast program. In such a case, it suffices to handle the program in the same manner as in the case of the serial broadcast program or one of a series of programs. In addition, if an already broadcast program and a program to be broadcast are similar in a predetermined attribute, e.g., genre, content, or performer, (even if they are different programs), the program can be handled in the same manner as in the case of the serial broadcast program/one of a series of programs or the rebroadcast program.

Note that it is also possible to implement the above respective functions by describing them as software and causing a computer having a proper mechanism to process the software.

In addition, this embodiment can be executed as a program for causing a computer to execute a predetermined procedure, or causing the computer to function as a predetermined means, and causing the computer to implement a predetermined function. In addition, the embodiment can be executed as a computer-readable recording medium recording the program.

According to the embodiments above, it is realized to provide a user recommended programs matching the performer preferences and habits of the user.

What is claimed is:

1. A recommended program information providing apparatus comprising:
a first memory to store history information of a user, the history information including viewing results corresponding to broadcast programs which are broadcast in the past, each of the viewing results indicating whether the user views or not corresponding one of the broadcast programs;
a second memory to store a preference model describing a causal relationship between the viewing results of the user and a plurality of causes leading to the viewing results;
a third memory to store program guide information including information concerning a plurality of programs to be broadcast;
a calculation unit configured to calculate a recommendation degree of each of the programs to be broadcast based on the preference model and the program guide information;
a selection unit configured to select, from the programs to be broadcast, a recommended program based on the recommendation degree of each of the programs to be broadcast and a viewing result in the history information, the viewing result corresponding to one of the broadcast programs which has a specific relationship with the each of the programs to be broadcast in a predetermined period in the past; and
a generation unit configured to generate recommended program information including information concerning the recommended program.

2. The apparatus according to claim 1, wherein the selection unit selects the recommended program based on the recommendation degree of the each of the programs to be broadcast and the viewing result corresponding to the one of the broadcast programs which is the same program as the each of the programs to be broadcast.

3. The apparatus according to claim 1, wherein the selection unit selects, as the recommended program, one of a series of programs which is included in the programs to be broadcasted, the recommendation degree of the one of the series of programs or a rank based on the recommendation degree of the one of the series of programs satisfy a predetermined condition and the viewing result corresponding to the one of the broadcast programs which precedes the one of the series of programs indicating that the user will view the program.

4. The apparatus according to claim 1, wherein the selection unit selects, as the recommended program, a repeat which is included in the programs to be broadcast, the recommendation degree of the repeat or a rank based on the recommendation degree of the repeat satisfy a predetermined condition and the viewing result corresponding to the one of the broadcast programs which is the same program as the repeat indicating that the user will not view the program.

5. The apparatus according to claim 1, wherein the calculation unit corrects, to a lower value, the recommendation degree of one of a series of programs which is included in the programs to be broadcast, when the viewing result corresponding to the one of the broadcast programs which precedes the one of the series of programs indicating that the user will not view the program.

6. The apparatus according to claim 1, wherein the calculation unit corrects, to a higher value, the recommendation degree of one of a series of programs which is included in the programs to be broadcasted, when the viewing result corresponding to the one of the broadcast programs which precedes the one of the series of programs indicating that the user will view the program.

7. The apparatus according to claim 1, wherein the calculation unit corrects, to a lower value, the recommendation degree of a repeat which is included in the programs to be broadcast, when the viewing result corresponding to the one of the broadcast programs which is the same program as the repeat indicating that the user views the program.

8. The apparatus according to claim 1, wherein the calculation unit corrects, to a higher value, the recommendation degree of a repeat which is included in the programs to be broadcast, when the recommendation degree of the repeat is not less than a predetermined reference value and the viewing result corresponding to the one of the broadcast programs which is the same program as the repeat indicating that the user doesn't view the program.

9. The apparatus according to claim 1, wherein the selection unit selects the recommended program from a group of programs of the programs to be broadcasted, the recommendation degree of each program of the group is not less than a predetermined lower limit.

10. The apparatus according to claim 1, wherein the selection unit selects the recommended program from a group of programs of the programs to be broadcasted, a rank of the recommendation degree of each program of the group is not less than a predetermined lower limit rank.

11. The apparatus according to claim 1, wherein the recommendation degree of each program to be broadcast is a viewing probability value indicating a probability that the user will view the each program to be broadcasted.

12. The apparatus according to claim 1, wherein the causes are based on attributes of the broadcast programs, and
the program guide information includes attribute information of the programs to be broadcast.

13. The apparatus according to claim 1, wherein the causes includes a genre of each broadcast program, preference concerning a performer on the each broadcast program, and preference concerning content of the each broadcast program.

14. The apparatus according to claim 1, further comprising a preference model generation unit configured to generate the preference model based on program guide information including attribute information of the broadcast programs in a predetermined period in the past and the history information.

15. The apparatus according to claim 1, further comprising a transmission unit configured to transmit the recommended program information to a terminal apparatus of the user.

16. A recommended program information providing method comprising:
storing history information of a user in a first memory, the history information including viewing results corresponding to broadcast programs which are broadcast in the past, each of the viewing results indicating whether the user views or not corresponding one of the broadcast programs;
storing, in a second memory, a preference model describing a causal relationship between the viewing results of the user and a plurality of causes leading to the viewing results;
storing, in a third memory, program guide information including information concerning a plurality of programs to be broadcast;
calculating a recommendation degree of each of the programs to be broadcasted based on the preference model and the program guide information;
selecting, from the programs to be broadcast, a recommended program based on the recommendation degree of each of the programs to be broadcast and a viewing result in the history information, the viewing result corresponding to one of the broadcasted programs which has a specific relationship with the each of the programs to be broadcast in a predetermined period in the past; and
generating recommended program information including information concerning the recommended program.
